(19) United States
(12) Patent Application Publication
(10) Pub. No.: US 2019/0318548 A1
(43) Pub. Date: Oct. 17, 2019

(54) METHOD AND APPARATUS FOR MATCHING VIRTUAL SPACE TO REAL SPACE NON-RIGID BODY

(71) Applicant: Electronics and Telecommunications Research Institute, Daejeon (KR)

(72) Inventors: Yong Sun KIM, Daejeon (KR); Hye Mi KIM, Daejeon (KR); Ki Tae KIM, Seongnam-si Gyeonggi-do (KR); Ki Hong KIM, Sejong-si (KR)

(73) Assignee: Electronics and Telecommunications Research Institute, Daejeon (KR)

(21) Appl. No.: 16/383,895

(22) Filed: Apr. 15, 2019

(30) Foreign Application Priority Data
Apr. 16, 2018 (KR) 10-2018-0043734

(51) Int. Cl. G06T 19/20; G06T 7/11; G06T 7/246

(52) U.S. Cl. CPC G06T 19/20; G06T 7/11; G06T 2219/2021; G06T 2207/10028; G06T 2207/10024; G06T 7/251

(57) ABSTRACT

The present invention relates to a method and an apparatus for matching a virtual object in a virtual environment, the method including generating a point cloud of a non-rigid object, matching a low resolution virtual model to the point cloud, and implementing a high resolution model using the matched model.

### CROSS REFERENCE TO RELATED APPLICATION

The present application claims priority to Korean Patent Application No. 10-2018-0043734, filed Apr. 16, 2018, the entire contents of which are incorporated herein for all purposes by this reference.

### BACKGROUND OF THE INVENTION

### Field of the Invention

The present invention relates to a method of matching and deforming a virtual object to a real object so that the shape of the virtual object corresponds to the shape of the real object in order to track changes in environment of the real space and apply the changes of the real environment to the virtual environment.

### Description of the Related Art

In the most existing virtual reality systems, a user wearing an HMD sits in a fixed place and interacts with virtual objects while enjoying contents such as games in virtual space completely separated from real space.

Recently, in a walking virtual reality system, users can move and experience the virtual reality in an indoor space. Most virtual reality systems are shooting games wherein a player fights with virtual enemies using gun models, in which the position and directions of the gun model are tracked by tracking a marker attached to the gun model. This gun model is a rigid body and has no change in shape. The virtual gun model in the virtual contents moves according to the movements of the actual gun model. In the case of other rigid bodies other than the gun model, the positions and directions of the rigid body can be determined by attaching a marker to track the positions thereof. In the case of such rigid body, an interaction between the real object and the virtual object is possible because the virtual object moves according to the real object by tracking the marker.

As virtual reality has developed, there is a growing interest in interaction with non-rigid bodies in real environments. In case of a non-rigid body such as curtains existing in the real environment, unlike a rigid body capable of being tracked using only one marker, it is necessary to arrange the markers very closely to track the non-rigid body.

However, it is very difficult to construct a unique set of markers for distinguishing between markers, it is likely to fail in tracking the non-rigid body when the markers are not identified or the markers are hidden. In addition, in the case of a non-rigid body with severe curvature, it is necessary to add an infinite number of markers to represent virtual non-rigid body naturally.

Thus, there is a need to represent the non-rigid body naturally by matching and tracking the non-rigid body without markers.

### SUMMARY OF THE INVENTION

The present invention has an objective to enable interaction with non-rigid bodies in experiencing virtual reality contents.

The present invention has an objective to propose a configuration and a method of a matching algorithm in which a non-rigid body model in virtual space is transformed according to the movement of a non-rigid body in real space.

An object of the present invention is to enable using virtual reality contents without using markers in order to overcome the limitation of the marker tracking method.

The present invention has an objective to match a virtual model to 3D information of a non-rigid body obtained from RGBD image and track and transform the virtual model.

It will be appreciated that the technical objects to be achieved by the present disclosure are not limited to the above-mentioned technical objects, and other technical objects which are not mentioned are to be clearly understood from the following description to those skilled in the art.

According to an embodiment of the present invention, a method of matching a virtual space in a virtual environment may be provided. The method includes receiving images from one or more cameras; separating a first object region from the received images and generating a point cloud of the first object; and matching a virtual mesh model to the generated point cloud, in which the first object may be a non-rigid body object, the virtual mesh model may be a low resolution model, and a high resolution model of the first object may be implemented by using a model generated by matching the virtual mesh model to the point cloud.

In addition, when the high resolution model is implemented by using the model generated by matching the virtual mesh model to the point cloud, a vertex of mesh vertices of the generated model may be selected as a control point, a movement of the mesh vertex on the implemented high resolution model corresponding to the control point may be calculated, and the high resolution model may be transformed on the basis of the calculated movement of the mesh vertex.

According to an embodiment of the present invention, the method may use a Moving Least Squares algorithm.

According to an embodiment of the present invention, one of the mesh vertices of the implemented high resolution model may be selected as a first control point, and the high resolution model may be transformed by tracking the first control point.

According to an embodiment of the present invention, wherein the matching of the virtual mesh model to the point cloud and the selecting of the first control point, and the transforming of the high resolution model by tracking the first control point may be performed in parallel.

According to an embodiment of the present invention, in a case of transforming the high resolution model by tracking the first control point, when the received image is a 2D image, a second control point may be calculated by projecting the selected first control point onto a 2D image coordinate system, the second control point may be tracked, the first control point may be re-acquired by projecting the tracked second control point onto a 3D space, and the high resolution model may be transformed by tracking the acquired first control point.

According to an embodiment of the present invention, when there are two or more cameras and two or more first control points, one control point may be made by performing filtering on the two or more first control points.

According to an embodiment of the present invention, when comparing a second control point of a former frame of two consecutive frames of the received 2D image with a second control point of a latter frame, information on a similarity of pixel colors and a similarity of patches between the second control points may be used as information for tracking the second control points to perform the tracking.

According to an embodiment of the present invention, the first control point may be selected by comparing a degree of curvature of the first object implemented with the high resolution model and a color difference between the mesh vertices.

According to an embodiment of the present invention, when comparing a first control point of a former frame of two consecutive frames of the received image with a first control point of a latter frame, a similarity of vertex colors and a similarity of local 3D structures between the first control points may be used as information for tracking the first control point, and the tracking may be performed on the point cloud of the first object.

According to an embodiment of the present invention, the matching may be performed by using an Iterative Closest Point algorithm.

According to an embodiment of the present invention, an apparatus for matching a virtual space in a virtual environment may be provided. The apparatus includes a matching unit matching a virtual model to a point cloud of a real object, in which the matching unit receives images from one or more cameras; separates a first object region from the received images and generating a point cloud of the first object; and matches a virtual mesh model to the generated point cloud, wherein the first object may be a non-rigid body object, the virtual mesh model may be a low resolution model, and a high resolution model of the first object may be implemented by using a model generated by matching the virtual mesh model to the point cloud.

According to an embodiment of the present invention, the apparatus may further include a tracking unit, in which the tracking unit may transform the high resolution model by tracking the first control point.

According to the present invention, it is possible to provide a method of enabling interaction with non-rigid bodies in experiencing virtual reality contents.

According to the present invention, it is possible to propose a configuration and a method of a matching algorithm in which a non-rigid body model in virtual space is transformed according to the movement of a non-rigid body in real space.

According to the present invention, it is possible to use virtual reality contents without using markers.

According to the present invention, it is possible to propose a method of matching virtual model to 3D information of a non-rigid body obtained from RGBD image and tracking and transforming the virtual model.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a flow chart illustrating matching of a non-rigid body;

FIG. 2 is a block diagram illustrating fast matching according to an embodiment of the present invention;

FIG. 3 is an execution example of low-resolution model matching according to an embodiment of the present invention;

FIG. 4 is an execution example of high resolution model modification according to an embodiment of the present invention;

FIG. 5 is a flowchart of matching and tracking procedures using a matching unit and a tracking unit;

FIG. 6 is a flowchart illustrating a procedure tracking control points of a non-rigid body in a 3D image;

FIG. 7 is a flowchart illustrating a procedure of tracking control points of a non-rigid body in a 2D image; and

FIG. 8 is a diagram showing a configuration of an apparatus for matching virtual space.

### DETAILED DESCRIPTION OF THE INVENTION

Hereinafter, embodiments of the present invention will be described in detail with reference to the accompanying drawings so that those skilled in the art can easily carry out the present invention. The present invention may, however, be embodied in many different forms and should not be construed as limited to the embodiments set forth herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, the components described in the various embodiments do not necessarily mean essential components, and some may be optional components. Accordingly, embodiments consisting of a subset of the components described in an embodiment are also included within the scope of this disclosure. Also, embodiments that include other components in addition to the components described in the various embodiments are also included in the scope of the present disclosure.

The present invention relates to a method of matching and deforming a virtual object to a real object so that the shape of the virtual object corresponds to the shape of the real object in order to track changes in environment of the real space and apply the change of the real environment to the virtual environment.

Hereinafter, embodiments of the present invention will be described with reference to the accompanying drawings.

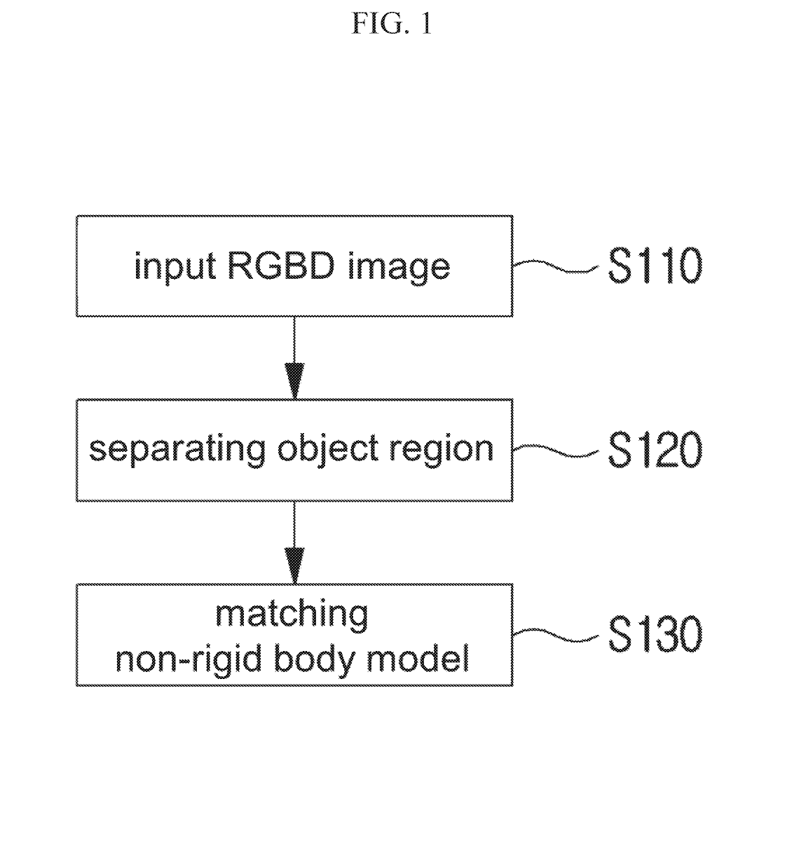

FIG. 1 is a flowchart illustrating matching of a non-rigid body.

First, a point cloud of an object can be generated by separating an object region from one or more camera images (S110 and S120).

The camera can be an RGBD (Red-Green-Blue Depth) camera, and the RGBD camera may be utilized by Microsoft's Kinect, Intel RealSense, and the like.

In the case of a plurality of RGBD cameras, a 3D point cloud may be created after conversion into the same coordinate system through a calibration process to find a conversion relation between cameras. Non-rigid body model matching that matches virtual object model to the 3D point cloud of real object may be performed using a non-rigid iterative closest point (ICP) algorithm (S130).

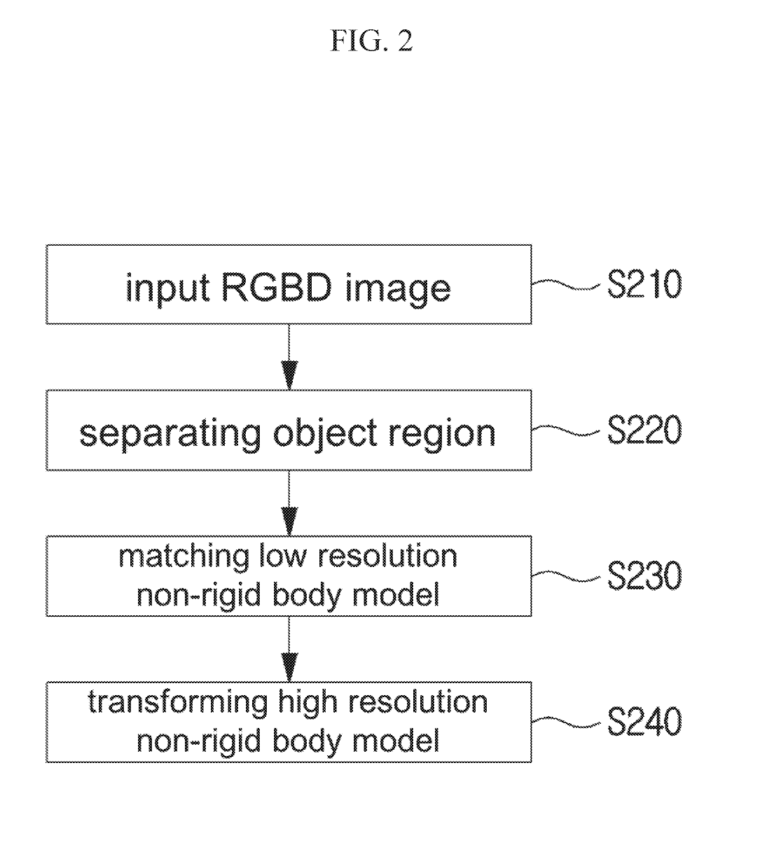

In FIG. 1, the matching algorithm is applied to every frame obtained from a camera, so that the virtual object may be transformed according to changes in the real object. However, when applying the matching algorithm every frame, it requires much time. Therefore, fast matching is proposed as shown in FIG. 2.

The non-rigid body matching algorithm according to an embodiment of the present invention may be performed by minimizing an energy function defined between the virtual model mesh and the real object's point cloud to obtain the vertex movements of the virtual model.

Equation 1 may correspond to the energy function according to an embodiment of the present invention. The energy function may include a distance term (Ed) which is a term indicating that the distance is minimized between the mesh vertex and the corresponding point in the point cloud, and a stiffness term (Es) which is a term indicating that the movement of the vertex connected to the edge should be similar within the mesh.

E(X)=E_{d}(X)+αEₛ(X) [Equation 1]

The distance term is equal to the sum of squares of the distances between the vertices of the virtual model and the closest points in the point cloud of the real object, as defined in Equation 2 below.

$${E}_{d} ( X ) = {\sum }_{{v}_{i}} {w}_{i} {‖ {X}_{i} - ( {v}_{i} - {u}_{i} ) ‖}^{2} = {‖ W ( X - ( V - U ) ) ‖}_{F}^{2} \qquad [ Equation 2 ]$$

In Equation 2, v is the vertex of the virtual model mesh and u is a point in the point cloud corresponding to the vertex. W represents a weight corresponding to each corresponding relationship.

The stiffness term is a term indicating that the movement of the vertex connected by the edge in the mesh should be similar, as defined in Equation 3.

Eₛ(x)=∥MX∥_{F}² [Equation 3]

In Equation 3, M represents a node-arc incidence matrix of the mesh.

FIG. 2 is a block diagram illustrating fast matching according to an embodiment of the present invention.

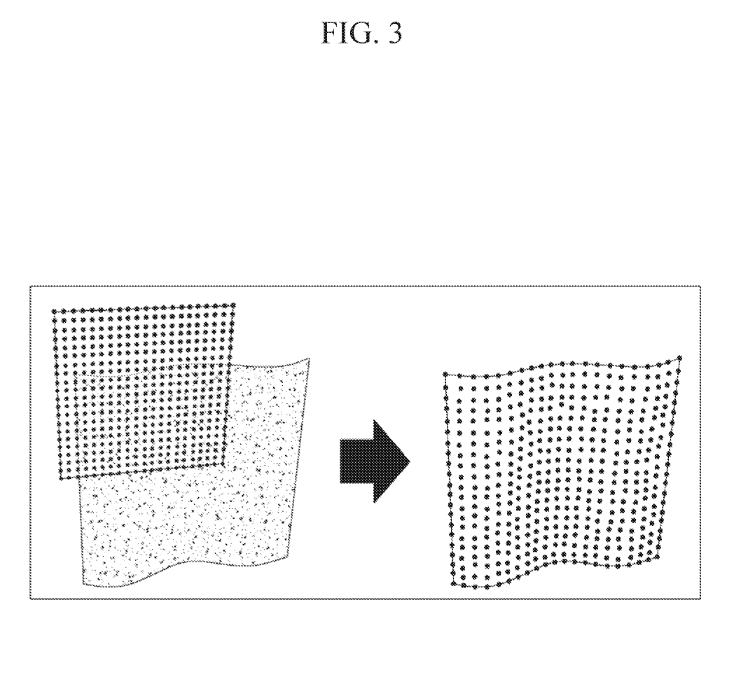

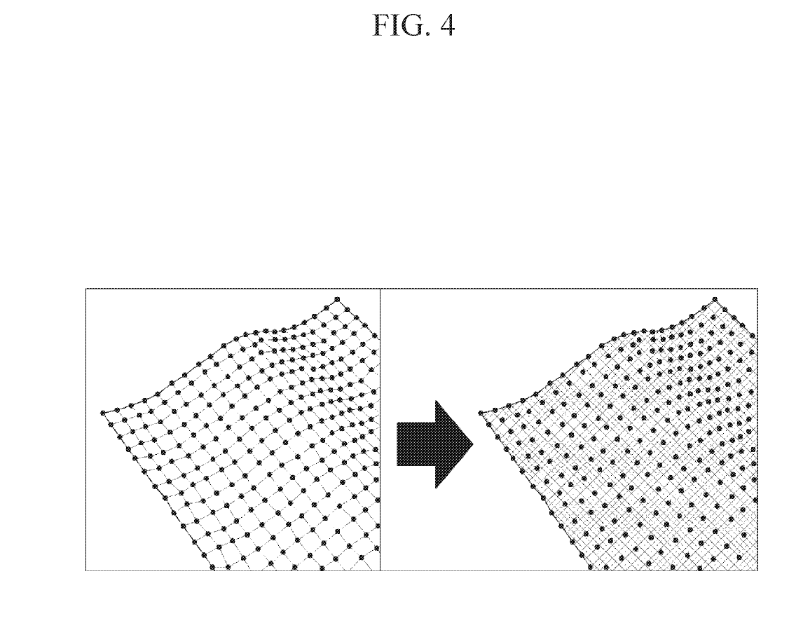

In addition, FIG. 3 is an execution example of low-resolution model matching according to an embodiment of the present invention, and FIG. 4 is an execution example of high resolution model modification according to an embodiment of the present invention.

An object region is separated from one or more RGBD camera images and a 3D point cloud of the object is generated (S210 and S220).

The first object refers to an object of a camera image, and may be a non-rigid body.

The virtual non-rigid body model is made of low-resolution model and high-resolution model. The virtual non-rigid body model may be constructed in the form of a mesh. The point cloud of the object is matched with the virtual low-resolution non-rigid body model (S230). The matching algorithm uses non-rigid ICP. FIG. 3 shows an execution example of matching the low resolution model to the point cloud of the object.

Using the matched low-resolution mesh vertex as a control point, the movement of the high resolution mesh vertex is calculated and the high resolution mesh model is transformed (S240). FIG. 4 is an execution example of high resolution model transformation. To calculate the position of high resolution vertex using the low resolution control point, the vertex movement is approximated with two-dimensional polynomial using a Moving Least Squares algorithm.

Although the fast matching of FIG. 2 is applied every frame, it is possible to reduce the time required for matching through matching of the low resolution model.

The model transformation method according to an embodiment of the present invention is a method of interpolating vertex movements using a Moving Least Squares algorithm. The movement of each vertex of the high resolution model is calculated to be approximated with the two dimensional polynomial using the movement of the peripheral control point.

$${min}_{{T}_{X}} {\sum }_{i} {w}_{i} {‖ {T}_{X} ( {p}_{i} ) - {q}_{i} ‖}^{2} \qquad [ Equation 4 ]$$

In Equation 4, w is the weight according to the distance between the vertex and the control point, p and q are an original position and a changed position for the control point, respectively, and Tx is the transformation model coefficient at the vertex x.

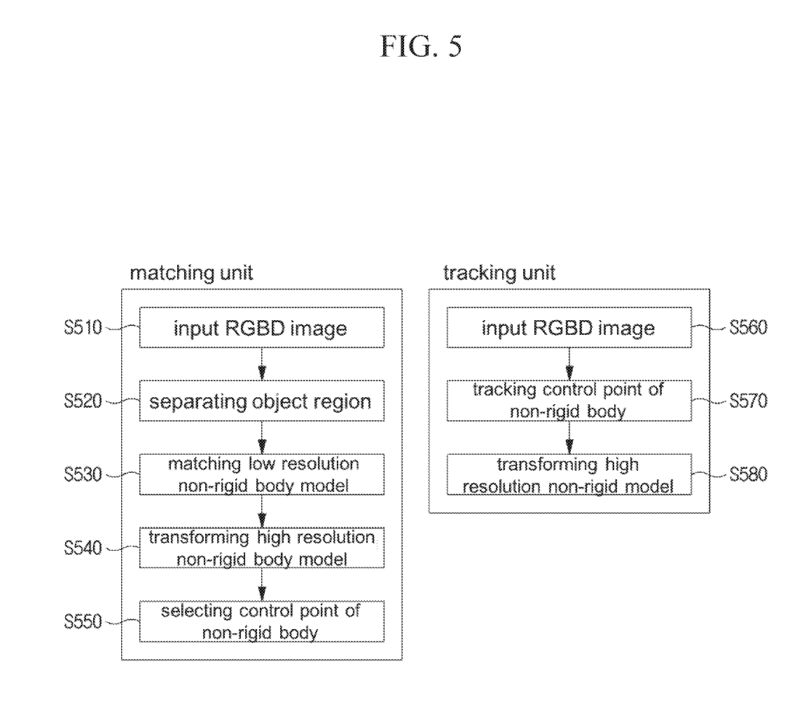

FIG. 5 is a flowchart illustrating procedures of matching and tracking using a matching unit and a tracking unit.

FIG. 5 shows a method using matching and tracking, unlike the method of matching every frame in FIGS. 1 and 2.

As shown in FIG. 5, a method of matching a virtual non-rigid body to a real non-rigid body is performed by a matching unit and a tracking unit.

As shown in FIG. 2, the matching unit separates an object region from one or more RGBD camera images and then creates 3D point cloud (S510 and S520). The low resolution non-rigid body model is matched to the 3D point cloud (S530), and then high-resolution non-rigid body model is transformed using the low resolution non-rigid body model as a control point (S540). A first control point for tracking is selected from the transformed non-rigid body model (S550).

The first control point may be a control point selected to transform the high resolution model through tracking of the tracking unit, and may be referred to a control point selected in the 3D screen. The first control point may be selected by comparing the degree of curvature of the first object implemented with the high resolution model and the color difference between the surrounding vertices in the model. In addition thereto, the method of selecting the control points in the high-resolution mesh may utilize other equally spaced sampling, random sampling, and the like. More specifically, a vertex located at a portion where the bending of the model is severe or a vertex having a large difference from the surrounding vertex color is selected as the first control point, thereby facilitating the deformation and tracking of the model.

However, the selection of the control point for tracking the non-rigid body may be possible in a low resolution mesh. When selecting the control point for tracking the non-rigid body, the vertex of the low resolution mesh may be used as the control point of the high resolution mesh transformation as it is without a distinct feature point in the high resolution mesh. The set of vertices of the high resolution mesh contains vertices of the low resolution mesh. More specifically, the control point may be used only as the vertex of the low resolution model when the model has less curvature or less difference in color value.

After the matching is performed for the first frame, when the control point is selected, the tracking unit tracks the positions of control point of the non-rigid body every frame (S570) and transforms the high resolution non-rigid body model on the basis of movements of the control point (S580). The matching is performed even when the tracking of non-rigid body control point fails, thereby allowing the control points to be reselected and tracked.

Herein, the delay time due to matching may occur. As another example, the matching and tracking are processed in parallel, thus a result of the parallel matching may be immediately used in case of tracking failure. In addition, the control point of the non-rigid body may be updated periodically through parallel processing of the matching to reduce drift errors caused by tracking.

The tracking of the control point of the non-rigid body may be performed in 3D and 2D.

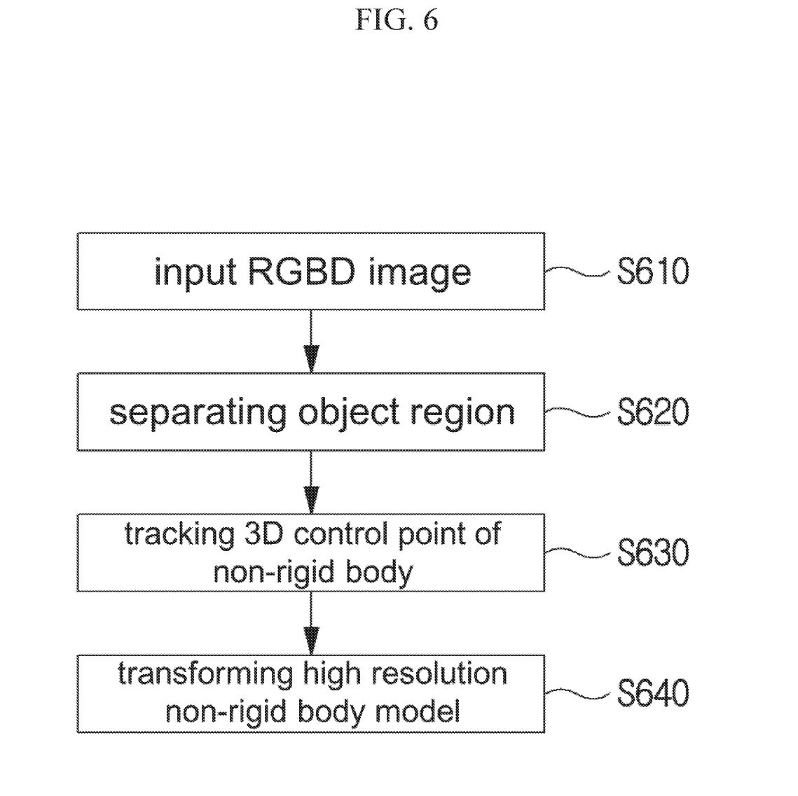

FIG. 6 is a flowchart illustrating the procedure of tracking control points of the non-rigid body in 3D.

The non-rigid body region is separated from one or more RGBD camera images to generate 3D point cloud (S610 and S620). The 3D control point is tracked on the 3D point cloud (S630).

The first control point may perform tracking through comparison between the point cloud of the previous frame and the point cloud of the current frame. The points to be tracked may be 3D points corresponding to the control points of the model. The tracking may be performed on the point cloud of the first object. More specifically, the information for tracking the first control point may be determined by comparing the similarity of the vertex color and the similarity of the local 3D structure.

The high resolution non-rigid body model is transformed using the movement of 3D control points (S640).

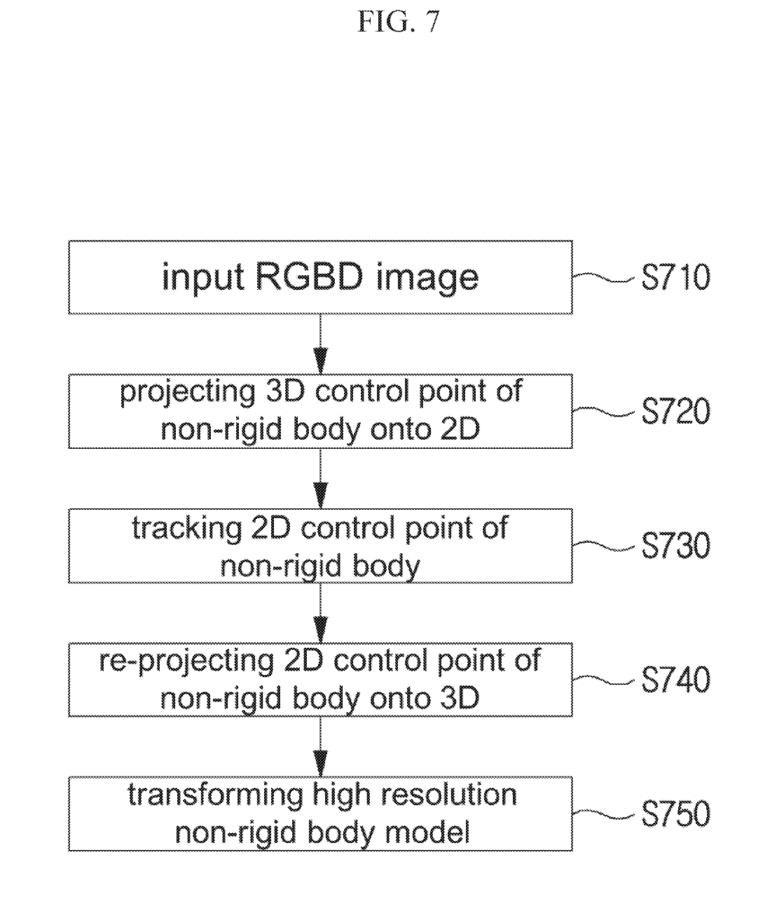

FIG. 7 is a flowchart illustrating the process of tracking control points of a non-rigid body in a 2D image.

First, one or more RGBD images are acquired (S710). The 3D control points of the non-rigid body obtained by the matching unit are projected onto a coordinate system of the RGBD image respectively to calculate the second control point (S720). The second control point is tracked on each of the RGBD images (S730).

The second control point is a control point on the 2D screen, and may be a 2D control point of the non-rigid body.

The tracking is performed through a comparison between the previous frame and the current frame of the 2D image. The points to be tracked is obtained by projecting the control point selected in the high resolution first object model onto 2D image, and may correspond to a second control point. More specifically, the second control point may be tracked using the pixel color similarity and the patch similarity.

The 3D control points of the non-rigid body are calculated by re-projecting the tracked 2D control points onto the 3D space (S740).

When using multiple RGBD cameras, one 3D control point is projected onto multiple RGBD image coordinate systems, and 3D control points obtained by re-projecting the 2D control points tracked from multiple RGBD images may not be re-projected as a single point due to tracking errors. Therefore, the 3D control points are combined as a single control point through filtering. Using the movements of such 3D control points of the non-rigid body, the high resolution non-rigid body model is transformed (S750).

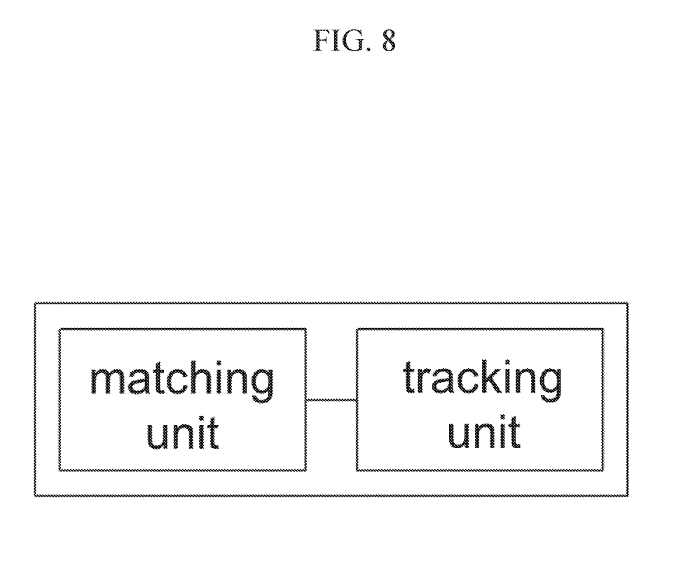

FIG. 8 is a diagram showing a configuration of an apparatus for matching virtual space (hereinafter, referred to a “virtual space matching apparatus”).

The virtual space matching apparatus may include a matching unit and a tracking unit.

The matching unit serves to match the virtual model to the point cloud of the real object. More particularly, the matching unit receives images from one or more cameras, separates a first object region from the received image to generate the point cloud of the first object, and matches the virtual mesh model to the generated point cloud.

Herein, the matching unit may be configured such that when the first object is a non-rigid body, and the virtual mesh model is a low resolution model, the high resolution model of the first object is implemented using the model generated by matching the low resolution virtual mesh model to the point cloud.

When the matching unit implements the high resolution model using the model generated by matching the low resolution virtual mesh model to the point cloud, one of mesh vertices of the generated model is selected as a control point, the movement of high resolution model mesh vertex corresponding to the control point is calculated, and the high resolution model is transformed on the basis of the calculated movement of the mesh vertex. Herein, in order to calculate the position of high resolution vertex using the low resolution control point, a Moving Least Squares algorithm is used and the vertex movement is approximated by a two-dimensional polynomial.

The matching unit may select one of the mesh vertices of the implemented high resolution model as the first control point.

The tracking unit may track the first control point to transform the high resolution model.

The performance at the matching unit and the tracking unit may be made in parallel. More specifically, the matching of the virtual model to the point cloud and selecting of the first control point at the matching unit, and the transforming of the high resolution model by tracking the first control point at the tracking unit are performed in parallel.

The virtual object matching apparatus may track the control points of the non-rigid body in a 2D image. In the case of transforming the high resolution model by tracking the first control point, when the received image is 2D, the selected first control point is projected onto the 2D image coordinate system to calculate the second control point, the second control point is tracked, the tracked second control point is projected onto 3D space to reacquire the first control point, and then the acquired first control point is tracked, thereby transforming the high resolution model.

1. A method of matching a virtual space in a virtual environment, the method comprising:
receiving images from one or more cameras;
separating a first object region from the received images and generating a point cloud of the first object; and
matching a virtual mesh model to the generated point cloud,
in which the first object is a non-rigid body object,
the virtual mesh model is a low resolution model, and
a high resolution model of the first object is implemented by using a model generated by matching the virtual mesh model to the point cloud.

2. The method of claim 1, wherein when the high resolution model is implemented by using the model generated by matching the virtual mesh model to the point cloud,
a vertex of mesh vertices of the generated model is selected as a control point,
a movement of the mesh vertex on the implemented high resolution model corresponding to the control point is calculated, and
the high resolution model is transformed on the basis of the calculated movement of the mesh vertex.

3. The method of claim 2, wherein a Moving Least Squares algorithm is used.

4. The method of claim 1, wherein one of the mesh vertices of the implemented high resolution model is selected as a first control point, and
the high resolution model is transformed by tracking the first control point.

5. The method of claim 4, wherein the matching of the virtual mesh model to the point cloud and the selecting of the first control point, and the transforming of the high resolution model by tracking the first control point are performed in parallel.

6. The method of claim 4, wherein the first control point is selected by comparing a degree of curvature of the first object implemented with the high resolution model and a color difference between the mesh vertices.

7. The method of claim 4, wherein when comparing a first control point of a former frame of two consecutive frames of the received image with a first control point of a latter frame, a similarity of vertex colors and a similarity of local 3D structures between the first control points are used as information for tracking the first control point, and
the tracking is performed on the point cloud of the first object.

8. The method of claim 4, wherein in a case of transforming the high resolution model by tracking the first control point, when the received image is a 2D image,
a second control point is calculated by projecting the selected first control point onto a 2D image coordinate system,
the second control point is tracked,
the first control point is re-acquired by projecting the tracked second control point onto a 3D space, and
the high resolution model is transformed by tracking the acquired first control point.

9. The method of claim 8, wherein when there are two or more cameras and two or more first control points, one control point is made by performing filtering on the two or more first control points.

10. The method of claim 8, wherein when comparing a second control point of a former frame of two consecutive frames of the received 2D image with a second control point of a latter frame, information on a similarity of pixel colors and a similarity of patches between the second control points are used as information for tracking the second control points to perform the tracking.

11. The method of claim 1, wherein the matching is performed by using an Iterative Closest Point algorithm.

12. An apparatus for matching a virtual space in a virtual environment, the apparatus comprising:
a matching unit matching a virtual model to a point cloud of a real object, in which the matching unit receives images from one or more cameras;
separates a first object region from the received images and generating a point cloud of the first object; and
matches a virtual mesh model to the generated point cloud,
wherein the first object is a non-rigid body object,
the virtual mesh model is a low resolution model, and
a high resolution model of the first object is implemented by using a model generated by matching the virtual mesh model to the point cloud.

13. The apparatus of claim 12, wherein when the matching unit implements the high resolution model by using the model generated by matching the virtual mesh model to the point cloud,
a vertex of mesh vertices of the generated model is selected as a control point,
a movement of the mesh vertex on the implemented high resolution model corresponding to the control point is calculated, and
the high resolution model is transformed on the basis of the calculated movement of the mesh vertex.

14. The apparatus of claim 12, wherein the matching unit selects one of the mesh vertices of the implemented high resolution model as a first control point.

15. The apparatus of claim 14, further comprising a tracking unit, in which the tracking unit transforms the high resolution model by tracking the first control point.

16. The apparatus of claim 15, wherein the matching of the virtual mesh model to the point cloud and the selecting of the first control point at the matching unit, and the transforming of the high resolution model by tracking the first control point at the tracking unit are performed in parallel.

17. The apparatus of claim 15, wherein in a case of transforming the high resolution model by tracking the first control point, when the received image is a 2D image,
a second control point is calculated by projecting the selected first control point onto a 2D image coordinate system,
the second control point is tracked,
the first control point is re-acquired by projecting the tracked second control point onto a 3D space, and
the high resolution model is transformed by tracking the acquired first control point.
